(19) United States
(12) Patent Application Publication
(10) Pub. No.: US 2023/0321597 A1
(43) Pub. Date: Oct. 12, 2023

(54) Method and Scavenging Mixture for Removing Hydrogen Sulfide from a Gas Stream

(71) Applicant: Foremark Performance Chemicals, League City, TX (US)

(72) Inventors: Jonathan R. Bingham, Mont Belvieu, TX (US); Lei Zhang, Houston, TX (US); Marlon Orlando Treasure, Houston, TX (US)

(73) Assignee: Foremark Performance Chemicals, League City, TX (US)

(21) Appl. No.: 18/188,733

(22) Filed: Mar. 23, 2023

Related U.S. Application Data
(60) Provisional application No. 63/322,963, filed on Mar. 23, 2022.

(51) Int. Cl. B01D 53/78; B01D 53/14; B01D 53/52

(52) U.S. Cl. CPC B01D 53/52; B01D 53/1468; B01D 53/1493; B01D 53/78; B01D 2252/20405; B01D 2252/20415; B01D 2252/20426; B01D 2252/20431; B01D 2252/20436; B01D 2252/504; B01D 2252/602

(57) ABSTRACT

Hydrogen sulfide is removed from a gas stream by bubbling a gas stream having ≥100 ppm hydrogen sulfide through a scavenging mixture. The scavenging mixture includes: 1) at least one sweetener selected from the group consisting of triazines, oxazolidines, hemiacetals, and mixtures thereof, and 2) at least one reaction catalyst selected from the group consisting of dipropyl amine (DPA), diethyl amine (DEA), dimethyl amine (DMA), pyrrole, and mixtures thereof. The scavenging mixture interacts with the hydrogen sulfide to produce a cleaned gas stream having ≤ 5 ppm hydrogen sulfide.

### CROSS-REFERENCE TO RELATED APPLICATIONS

This application claims the benefit, under 35 U.S.C. 119(e), of U.S. Provisional Application No. 63/322,963 filed Mar. 23, 2022, the contents of which are incorporated herein by reference.

### BACKGROUND OF THE INVENTION

MMA (monomethylamine) triazine (hexahydro-1,3,5-trimethyl-s-triazine) and MEA (monoethanolamine) triazine (hexahydro-1,3,5-tris(hydroxyethyl)-s-triazine) are commonly used to remove hydrogen sulfide from natural gas in a process called sweetening.

In many sweetening applications MMA triazine is not suited for use due to a slower reaction with hydrogen sulfide. For example in most natural gas wells that are high in sulfur (300 ppm or more) MMA triazine is not able to lower hydrogen sulfide levels to transportation specifications (often targeting ≤ 2 ppm) without overuse of MMA triazine (compared to MEA triazine on an equal molar basis). Typically MMA triazine is needing to be added at 30% greater rates (on a molar basis) to several times excess the amount of MEA triazine needed to lower hydrogen sulfide to pipeline specifications. The higher reactivity of MEA triazine makes MEA triazine the practical chemical for gas sweetening in tower application compared to MMA triazine.

Diamines, such as piperidine and, diethanolamine, have been used with triazines in low hydrogen sulfide applications. However, piperidine and, diethanolamine do not show a comparable scavenging increase at high sulfur applications. Other amines have solubility issues, such as diispropylamine, piperidine or dibutyl amine, and do not increase scavenging capability to the same level.

### SUMMARY OF INVENTION

Hydrogen sulfide may be removed from a gas stream by bubbling the hydrogen sulfide through a scavenger mixture. The scavenger mixture includes at least one sweetener and at least one reaction catalyst. The scavenging mixture interacts with the hydrogen sulfide to produce a cleaned stream having ≤ 5 ppm hydrogen sulfide.

### BRIEF DESCRIPTION OF THE DRAWINGS

The features and advantages of the present invention will become apparent from the following detailed description of a preferred embodiment thereof, taken in conjunction with the accompanying drawings, in which:

FIG. 1 is a graph showing that an aqueous scavenging mixture with 38% MMA triazine (MMAt) and 3 wt. % DPA significantly increase the breakthrough point vs. standard 40% MMA triazine (MMAt) in water; and

FIG. 2 is a photo showing that a scavenger mixture including MMA triazine (MMAt) with DPA also has significantly reduce solids formation.

### DETAILED DESCRIPTION OF THE INVENTION

Hydrogen sulfide is removed from a gas stream by bubbling a gas stream having ≥ 100 ppm hydrogen sulfide through a scavenging mixture. The scavenging mixture includes: 1) at least one sweetener selected from the group consisting of triazines, oxazolidines, hemiacetals, and mixtures thereof, and 2) at least one reaction catalyst selected from the group consisting of dipropyl amine (DPA), diethyl amine (DEA), dimethyl amine (DMA), pyrrole, and mixtures thereof. The scavenging mixture interacts with the hydrogen sulfide to produce a cleaned gas stream having ≤ 5 ppm hydrogen sulfide, or ≤ 3 ppm, or ≤ 2 ppm. In a preferred embodiment, the scavenging mixture is a solution, more preferably including water as the solvent.

In one embodiment, the only sweetener in the scavenging mixture is a triazine. In one embodiment, the only sweetener in the scavenging mixture is monomethylamine hexahydro-1,3,5-trimethyl-s-triazine (MMA triazine). In one embodiment, the only sweetener in the scavenging mixture is an oxazolidines. In one embodiment, the only sweetener in the scavenging mixture is an hemiacetal.

In one embodiment, the only reaction catalyst in the scavenging mixture is dipropyl amine (DPA). In one embodiment, the only reaction catalyst in the scavenging mixture is diethyl amine (DEA). In one embodiment, the only reaction catalyst in the scavenging mixture is dimethyl amine (DMA). In one embodiment, the only reaction catalyst in the scavenging mixture is pyrrole.

In one embodiment, the scavenging mixture includes: 1) 10-50 wt.% at least one sweetener selected from the group consisting of triazines, oxazolidines, hemiacetals, and mixtures thereof, and 2) 1-6 wt.% at least one reaction catalyst selected from the group consisting of dipropyl amine (DPA), diethyl amine (DEA), dimethyl amine (DMA), pyrrole, and mixtures thereof based on the total weight of said scavenging mixture; and at least one solvent. In a preferred embodiment, the scavenging mixture includes a solvent that is water. In one embodiment, the only solvent in the scavenging mixture is water.

In one embodiment, the scavenging mixture consists of : 10-50 wt.% monomethylamine hexahydro-1,3,5-trimethyl-s-triazine (MMA triazine) based on the total weight of said scavenging mixture, and 1-6 wt.% at least one reaction catalyst selected from the group consisting of dipropyl amine (DPA), diethyl amine (DEA), dimethyl amine (DMA), pyrrole, and mixtures thereof based on the total weight of said scavenging mixture; 44-89 wt.% water based on the total weight of the scavenging mixture; and ≤ 15 wt.% other ingredients based on the total weight of the scavenging mixture, or ≤ 10 wt.% other ingredients, or ≤ 5 wt. % other ingredients, or ≤ 2 wt.% other ingredients, or ≤ 1 wt.% other ingredients, or ≤ 0.5 wt.% other ingredients.

It is understood that the upper and/or lower limits for the amount of at least one reaction catalyst and/or triazines, oxazolidines, hemiacetals, and mixtures thereof and/or MMA triazine may be 1, 2, 3, 4, 5, or 6 wt.% based on the total weight of the scavenging mixture.

It is understood that the upper and/or lower limits for the at least one sweetener and/or dipropyl amine (DPA), diethyl amine (DEA), dimethyl amine (DMA), pyrrole, and mixtures thereof, may be 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt.%.

In one embodiment of the present invention, the scavenging mixture is an aqueous mixture including 44-89 wt.% water based on the total weight of the scavenging mixture. It is understood that the upper and/or lower limits for the amount of water may be 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88 or 89 wt.% based on the total weight of the scavenging mixture.

In a preferred embodiment, the scavenger mixture is an aqueous scavenger mixture that includes, comprises, and/or consists of 1 to 6 wt.% dipropyl amine (DPA), 10-50 wt.% MMA triazine (MMAt), and 44-89 wt.% water based on the total weight of the scavenging mixture. In a preferred embodiment, the aqueous scavenger mixture consists of 1 to 6 wt.% dipropyl amine (DPA), 10-50 wt.% MMA triazine (MMAt), 44-89 wt.% water, and ≤ 15 wt.%, or ≤ 10 wt.%, or ≤ 5 wt.%, or ≤ 1 wt.%, or ≤ 0.5 wt.% other ingredients based on the total weight of the scavenging mixture.

“Other ingredients” are defined as any chemical that would not material effect the properties of the present invention, e.g. the scavenging of hydrogen sulfide. In one embodiment, the “other ingredients” includes a stabilizer that lowers the vapor pressure of the at least one diamine. The stabilizer may be selected from the group consisting of acid, aldehyde, anhydride, ketone, solvent, polyol, surfactant, and mixtures thereof. More specifically, the stabilizer may be selected from the group consisting of formic acid, formaldehyde, butyraldehyde, maleic anhydride, and mixtures thereof. In one embodiment, the scavenging mixture includes 0.5-15 wt.% stabilizer that lowers the vapor pressure of the at least one reaction catalyst in said scavenger mixture. It is understood that the upper and/or lower limits for the stabilizers may be 0.5, 1, 2, 3, 4, 5, 6, 7, 8, 9, 10, 11, 12, 13, 14 or 15 wt.%.

In one embodiment, the scavenging mixture can increase the scavenging efficacy before breakthrough of hydrogen sulfide over 3 times compared to just MMA triazine (MMAt) in high sulfur applications, e.g. greater than ≥ 100,000 ppm hydrogen sulfide. For example, the breakthrough time for hydrogen sulfide levels at 2 ppm were greater than 125 minutes, or greater than 120 minutes, or greater than 100 minutes, or greater than 90 minutes. This allows MMA triazine (MMAt) to compete with MEA triazine on an equal molar basis. At these very high application rates this new scavenging mixture is expected to outperform MEA triazine at keeping hydrogen sulfide levels low and within specification needed for usage and transportation, such as ≤ 5 ppm, or ≤ 3 ppm, or ≤ 2 ppm.

For example at very high levels of sulfur, e.g. ≥ 100,000 ppm hydrogen sulfide, addition of DPA increases scavenging potential to 412% that of regular MMA triazine (MMAt). The closest commonly used scavenging amine piperazine increases scavenging to 219% of MMA triazine (MMAt) at 100,000 ppm hydrogen sulfide before hydrogen sulfide levels rise above 2 ppm.

The scavenging mixtures may increase performance in high sulfur applications, such as those with a gas stream having ≥100 ppm hydrogen sulfide, or ≥300 ppm, or ≥1000 pm, or ≥10,000 ppm, or ≥100,000 ppm.

In one embodiment, the scavenging mixture unexpectedly allows MMA triazine (MMAt) to be a practical replacement for MEA triazine in high sulfur applications applications. Historically MMA triazine (MMAt) was not a practical replacement of MEA triazine in these application and thus was not commercially used.

In one embodiment, in spite of the lower reactivity, MMA triazine (MMAt) has the advantage of not forming amorphous solids like MEA triazine when spent. Solids created by MMA triazine (MMAt) are crystalline and easily dissolved in solvents unlike MEA triazine solids.

Also, lab testing revealed an unexpected benefit of using a mixture of DPA combined with MMA triazine (MMAt). When DPA is combined with MMA triazine (MMAt) solids formation is dramatically reduced or eliminated compared to standard MMA triazine (MMAt). The capability of a mixture of DPA combined with MMA triazine (MMAt) to interact with hydrogen sulfide before solids formation is increased 4.12X in lab testing.

In one embodiment, in addition to DPA, scavenging mixtures, preferably a solution, including diamines such as diethylamine (DEA) and/or dimethylamine (DMA) and/or pyrrole combined with MMA triazine (MMAt) provide advantages in removing hydrogen sulfide from natural gas stream.

The following is an example of one embodiment of the present invention and is not intended to limit the scope of the present invention:

### Example

An aqueous scavenger mixture was prepared by adding 38 wt% MMAt and 3 wt% DPA with the remainder being water. The scavenger mixture was mixed to create a homogenous solution.

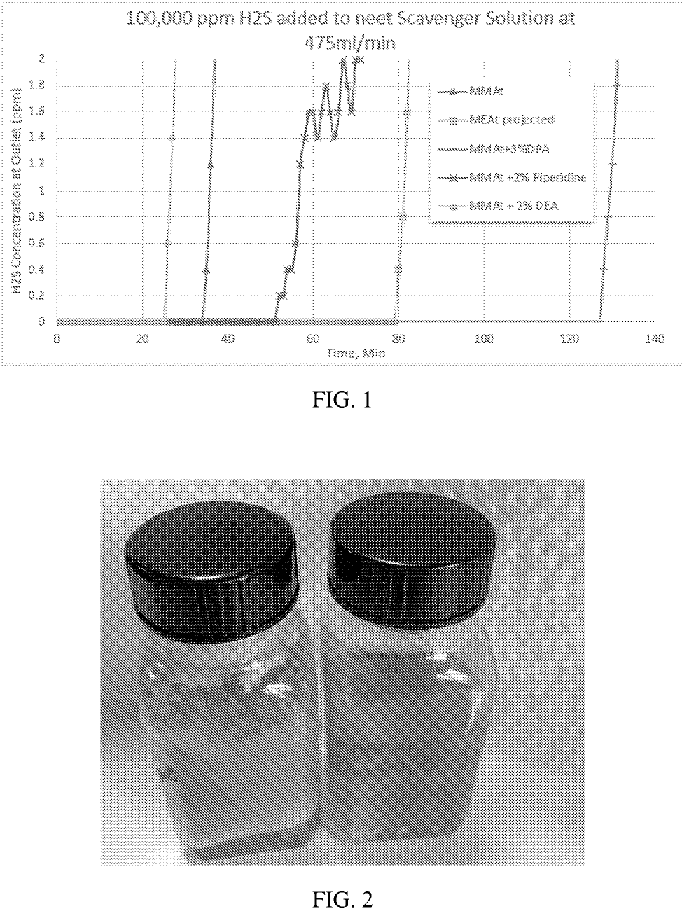

In an experiment to measure the breakthrough point of hydrogen sulfide in a gas stream, 300 ml of scavenger mixture had 100,000 ppm hydrogen sulfide in nitrogen bubbled through it at a rate of 475 ml of gas per minute. The gas above the scavenger was tested for hydrogen sulfide concentration (Y axis) and time of addition (X axis) were recorded. (See FIG. 1)

FIG. 1 shows that an aqueous scavenging mixture with 38% MMA triazine (MMAt) and 3 wt. % DPA significantly increase the breakthrough point vs standard 40% MMA triazine (MMAt) in water. By contrast, piperazine and DEA co-scavengers show much lower breakthrough points.

The scavenger mixture including MMA triazine (MMAt) with DPA was also shown to significantly reduce solids formation as seen in FIG. 2. The left sample is standard MMA triazine (MMAt) saturated with hydrogen sulfide after three days. In this example, solids started to appear on day one. The right sample is an aqueous scavenger mixture including 38% MMAt + 3 wt. % DPA with the remainder being water after being saturated with hydrogen sulfide after five days. No solids were formed in the sample with MMAt + 3 wt.% DPA; however there was some separation of phases. 2.2 times the amount of hydrogen sulfide was added to the MMAt + 3 wt.% DPA sample to try and force formation of solids. However, no solids appeared.

Although the present invention has been disclosed in terms of a preferred embodiment, it will be understood that numerous additional modifications and variations could be made thereto without departing from the scope of the invention as defined by the following claims:

1. A method for removing hydrogen sulfide from a gas stream comprising,
bubbling a gas stream having ≥100 ppm hydrogen sulfide through a scavenging mixture including 1) at least one sweetener selected from the group consisting of triazines, oxazolidines, hemiacetals, and mixtures thereof and 2) at least one reaction catalyst selected from the group consisting of dipropyl amine (DPA), diethyl amine (DEA), dimethyl amine (DMA), pyrrole, and mixtures thereof;
wherein said scavenging mixture interacts with said hydrogen sulfide to produce a cleaned gas stream having ≤5 ppm hydrogen sulfide.

2. The method of claim 1 wherein monomethylamine hexahydro∼1,3,5-trimethyl-s-triazine (MMA triazine) is the only sweetener in said scavenging mixture.

3. The method of claim 1 wherein said scavenging mixture includes 1-6 wt.% reaction catalyst based on the total weight of the scavenging mixture.

4. The method of claim 1 wherein said DPA is the only reaction catalyst in said scavenging mixture.

5. The method of claim 1 wherein DEA is the only reaction catalyst in said scavenging mixture.

6. The method of claim 1 wherein DMA is the only reaction catalyst in said scavenging mixture.

7. The method claim 1 wherein said scavenging mixture includes 10-50 wt.% at least one sweetener based on the total weight of the scavenging mixture.

8. The method of claim 1 wherein said scavenging mixture includes 44-89 wt.% water based on the total weight of the scavenging mixture.

9. A scavenging mixture comprising:
10-50 wt.% monomethylamine hexahydro-1,3,5-trimethyl-s-triazine (MMA triazine) based on the total weight of said scavenging mixture, and
1-6 wt.% at least one reaction catalyst selected from the group consisting of dipropyl amine (DPA), diethyl amine (DEA), dimethyl amine (DMA), pyrrole, and mixtures thereof based on the total weight of said scavenging mixture; and
at least one solvent.

10. The scavenging mixture of claim 9 wherein said at least one solvent is water.

11. The scavenging mixture of claim 10 comprising 44-89 wt.% water based on the total weight of the scavenging mixture.

12. The scavenging mixture of claim 9 wherein said DPA is the only reaction catalyst in said scavenging mixture.

13. The scavenging mixture of claim 9 wherein DEA is the only reaction catalyst in said scavenging mixture.

14. The scavenging mixture of claim 9 wherein DMA is the only reaction catalyst in said scavenging mixture.

15. The scavenging mixture of claim 9 further comprising 0.5-15 wt.% stabilizer that lowers the vapor pressure of the at least one reaction catalyst in said scavenger mixture.

16. The scavenging mixture of claim 15 wherein said stabilizer is selected from the group consisting of acid, aldehyde, anhydride, ketone, solvent, polyol, surfactant, and mixtures thereof.

17. The scavenging mixture of claims 15 wherein said stabilizer is selected from the group consisting of formic acid, formaldehyde, butyraldehyde, maleic anhydride, and mixtures thereof.

18. A scavenging mixture consisting of :
10-50 wt.% monomethylamine hexahydro-1,3,5-trimethyl-s-triazine (MMA triazine) based on the total weight of said scavenging mixture, and
1-6 wt.% at least reaction catalyst selected from the group consisting of dipropyl amine (DPA), diethyl amine (DEA), dimethyl amine (DMA), pyrrole, and mixtures thereof based on the total weight of said scavenging mixture;
44-89 wt.% water based on the total weight of the scavenging mixture; and
≤15 wt.% other ingredients based on the total weight of the scavenging mixture.

19. The scavenging mixture of claim 18 wherein said DPA is the only reaction catalyst in said scavenging mixture.

20. The scavenging mixture of claim 18 wherein said other ingredients is ≤1 wt.% of total weight of the scavenging mixture.
